(19) United States
(12) Patent Application Publication
(10) Pub. No.: US 2016/0204523 A1
(43) Pub. Date: Jul. 14, 2016

(54) CONDUCTION PATH AND ELECTRICAL WIRE

(71) Applicant: SUMITOMO WIRING SYSTEMS, LTD., Mie (JP)

(72) Inventor: Masahiro Hagi, Yokkaichi, Me (JP)

(21) Appl. No.: 14/911,063

(22) PCT Filed: Aug. 1, 2014
(86) PCT No.: PCT/JP2014/070309

§ 371 Date: Feb. 9, 2016

(30) Foreign Application Priority Data
Aug. 22, 2013 (JP) 2013-172009

(51) Int. Cl. H01R 4/20; H01R 43/048; H01R 4/18

(52) U.S. Cl. CPC H01R 4/20; H01R 4/183; H01R 43/048; H01R 4/187

(57) ABSTRACT

The contact reliability between bare wires constituting a conductor is improved. A conduction path includes a conductor that is configured by twisting a plurality of aluminum bare wires from which an oxide layer is removed, a bare wire solder that is welded to the conductor so as to restrict relative displacement of the plurality of bare wires, and a terminal fitting having a crimping part that surrounds and crimps a region of the conductor to which the bare wire solder is welded.

### CROSS-REFERENCE TO RELATED APPLICATIONS

This application is the U.S. national stage of PCT/JP2014/070309 filed Aug. 1, 2014, which claims priority of Japanese Patent Application 2013-172009 filed Aug. 22, 2013.

### FIELD OF THE INVENTION

The present invention relates to a conduction path and an electric wire.

### BACKGROUND OF THE INVENTION

In recent years, electric wires including a conductor obtained by twisting aluminum bare wires have been spreading as lightweight electric wires. However, an oxide layer is formed on the surfaces of the aluminum bare wires, and thus it is necessary to remove the oxide layers when the aluminum bare wires are crimped to a terminal fitting. As a method for removing the oxide layers and performing the crimping, JP 2009-231079A discloses a technique in which ultrasonic vibration is applied so as to slide the bare wires with respect to each other, thereby removing the oxide layers, the ultrasonic vibration is subsequently applied so as to preliminarily join the bare wires to each other, and then crimping is realized by compressing a crimping part of the terminal fitting against the conductor.

In the method in which ultrasonic vibration is applied so as to join the bare wires to each other, it is not possible to achieve a sufficiently high joining strength. Particularly, when the electric wire is used under a high-temperature environment due to being installed in a vehicle, the fixing strength of the crimping part surrounding the conductor is reduced, and as a result, the bare wires are separated from each other, increasing an electric resistance.

### SUMMARY OF THE INVENTION

The present invention was made in view of the above-described circumstances, and it is an object of the present invention to improve the contact reliability between bare wires constituting a conductor.

According to a first aspect, a conduction path includes a conductor including a plurality of aluminum bare wires from whose surfaces at an end an oxide layer is removed; solder that is welded to the conductor so as to restrict relative displacement of the plurality of bare wires from which the oxide layer is removed; and a terminal fitting having a crimping part that surrounds and crimps a region of the conductor to which the solder is welded.

Furthermore, according to a second aspect, an electric wire includes: a conductor including a plurality of aluminum bare wires from whose surfaces at an end an oxide layer is removed; and solder that is welded to the conductor so as to restrict relative displacement of the plurality of bare wires from which the oxide layer is removed; wherein a region of the conductor to which the solder is welded is configured to be crimped by a crimping part of a terminal fitting while being surrounded by the crimping part.

According to the first and second aspects, the fixing strength of the solder prevents the bare wires from being separated from each other, and thus the contact reliability between the bare wires is high.

25

### BRIEF DESCRIPTION OF DRAWINGS

FIG. 1 is a plan view of an electric wire that constitutes a conduction path according to Embodiment 1, illustrating the state before bare wire solder is welded to a conductor.

FIG. 2 is a cross-sectional view taken along the line X-X of FIG. 1;

FIG. 3 is a plan view illustrating the state in which the bare wire solder is welded to the conductor;

FIG. 4 is a cross-sectional view taken along the line Y-Y of FIG. 3;

FIG. 5 is a plan view illustrating the state in which the conductor of the electric wire is crimped to a terminal fitting; and

FIG. 6 is a cross-sectional view taken along the line Z-Z of FIG. 5.

### DETAILED DESCRIPTION OF THE PREFERRED EMBODIMENTS

The conduction path according to the first aspect may be configured such that the solder is welded so as to surround an entire outer circumference of the conductor. According to this configuration, expansion of the conductor is restrict, making it possible to reliably prevent the bare wires from being separated from each other.

The conduction path of the first aspect according may be configured such that the crimping part has a pair of compression pieces that extend in a cantilever manner so as to surround the conductor, and the compression pieces have an extension end part that penetrates the solder surrounding the conductor and is in direct contact with the bare wires. According to this configuration, the terminal fitting and the conductor are in direct contact with each other without the solder therebetween, thus making it possible to prevent an increase in the electric resistance.

The conduction path of the first aspect according may be further configured such that crimping solder is welded to the crimped on compression pieces. According to this configuration, the crimping solder restricts expansion, opening, and deformation of the compression pieces. Accordingly, it is possible to more reliably prevent the bare wires from being separated from each other.

The conduction path of the first aspect may be configured such that the solder is welded so as to cover end surfaces of the plurality of bare wires from which the oxide layer is removed and that are bundled together. According to this configuration, the solder enters the gaps between the bare wires, and thus it is possible to prevent creation of an oxide layer within the conductor.

The conduction path of the first aspect may be configured such that a portion of the conductor in a conductor-length direction that is compressed by the crimping part is only a part of the region of the conductor to which the solder is welded. According to this configuration, in that part of the solder-welded region that is not compressed by the crimping part, there is no risk that a crack occurs in the solder, making it possible to more reliably prevent the bare wires from being separated from each other.

The electric wire according to the second aspect may be configured such that the solder is welded so as to surround an entire outer circumference of the conductor. According to this configuration, expansion of the conductor is restricted, making it possible to reliably prevent the bare wires from being separated from each other.

The electric wire of the second aspect may be configured such that the solder is welded so as to cover end surfaces of the plurality of bare wires from which the oxide layer is removed and that are bundled together. According to this configuration, the solder enters the gaps between the bare wires, and thus it is possible to prevent creation of an oxide layer within the conductor.

Hereinafter, Embodiment 1 as an implementation of the present invention will be described with reference to FIGS. 1 to 6. As shown in FIG. 5, a conduction path “A” according to the present embodiment includes an electric wire 10 and a terminal fitting 20.

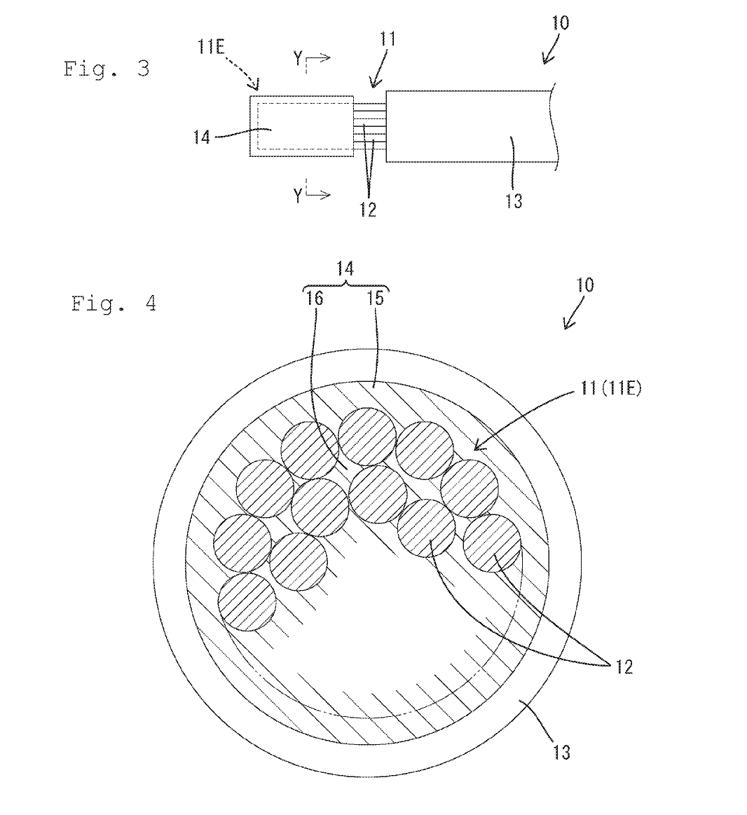

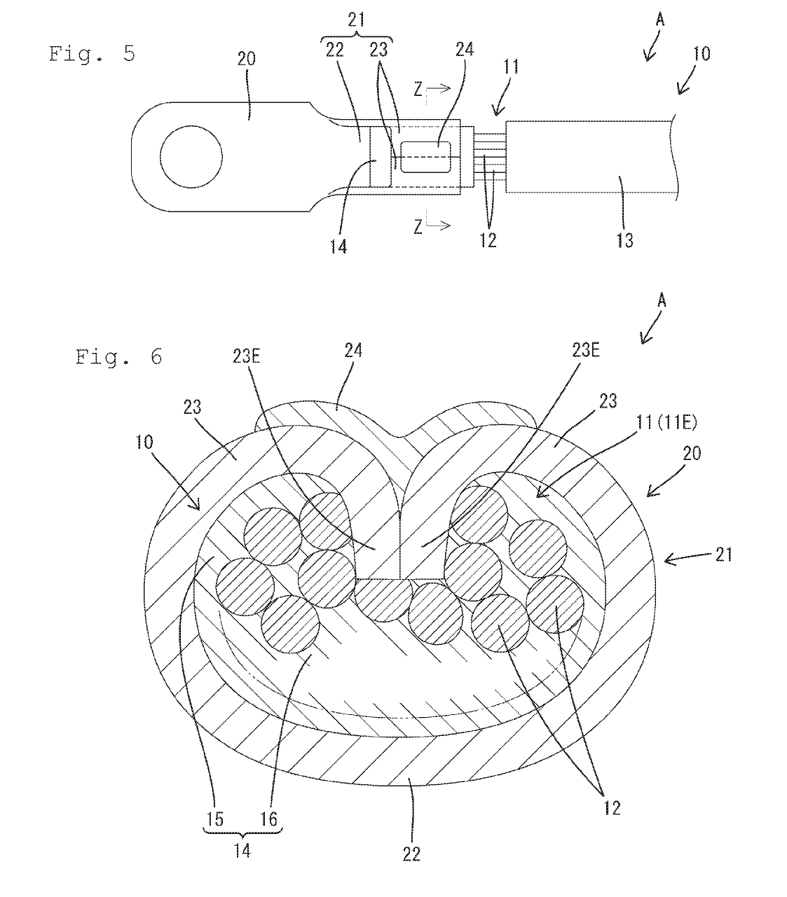

As shown in FIGS. 3 and 4, the electric wire 10 includes a conductor 11, an insulating coating 13 that is made of a synthetic resin and surrounds the conductor 11, and bare wire solder 14 (the “solder” recited in the claims) that is welded to an end of the conductor 11 from which the insulating coating 13 is removed and that is exposed (hereinafter, referred to as an “exposed end 11E”). The conductor 11 is formed by twisting a plurality of aluminum bare wires 12, and is shaped so as to have a circular cross-section as a whole. In the exposed end 11E of the conductor 11, each of the bare wires 12 is in direct contact with another adjacent bare wire 12. As shown in FIGS. 4 and 6, the bare wire solder 14 includes an outer layer part 15 that surrounds the entire outer circumference of the exposed end 11E of the conductor 11, and a filling part 16 that fills the gaps between the bare wires 12. In that region of the exposed end 11E of the conductor 11 that is surrounded by the outer layer part 15, the bare wires 12 are not in direct contact with outside air.

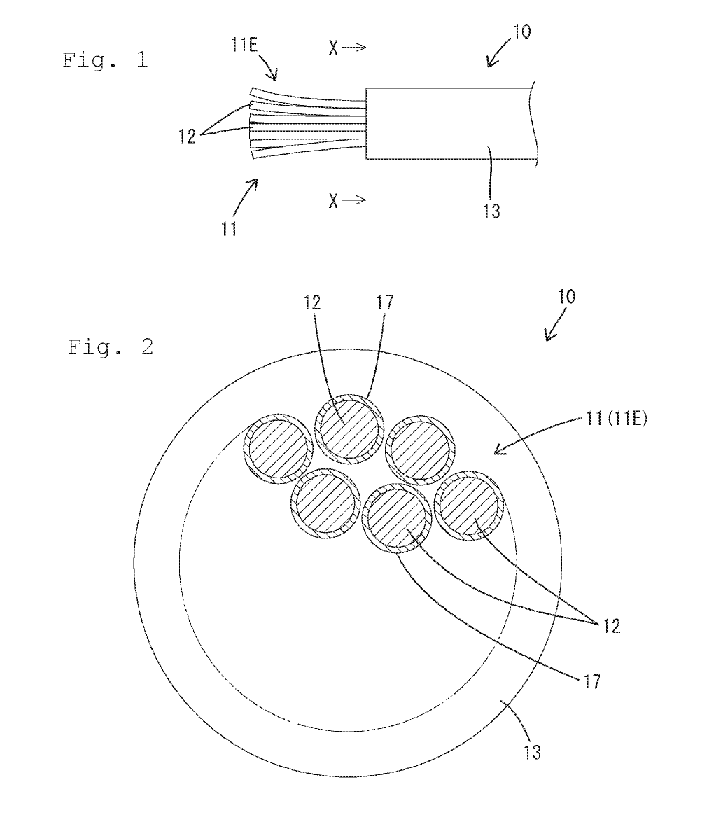

The electric wire 10 is manufactured by the following procedure. In the state before the bare wire solder 14 is welded to the electric wire 10, as shown in FIG. 1, the bare wires 12 are untwisted at the exposed end 11E of the conductor 11 and are in contact with outside air. Accordingly, as shown in FIG. 2, an oxide layer 17 is formed on the surface of each bare wire 12 at the exposed end 11E. Since the oxide layers 17 at the exposed end 11E increase the electric resistance, the oxide layers 17 are to be removed before the bare wire solder 14 is welded. As a method for removing the oxide layers 17, the exposed end 11E of the conductor 11 is dipped into a layer removing agent (not shown).

After the removal of the oxide layers, all the bare wires 12 are promptly bundled together so as to have a substantially circular cross-section. At this time, the bare wires 12 only need to be bundled together in the state of being substantially straight, without the need of being contorted and twisted. At this time, each bare wire 12 is preferably in direct contact with another, adjacent bare wire 12. However, some bare wires 12 may have the positional relationship in which they are aligned without being in contact with each other. Every bare wire 12 has an outer circumferential surface at least a part of which is not in contact with another bare wire 12.

After having bundled all of the plurality of bare wires 12 together, the bare wire solder 14 is welded to the exposed end 11E (that is, the region of the conductor 11 in which the oxide layers 17 have been removed from the surfaces of the bare wires 12) as shown in FIG. 3, promptly before an oxide layer 17 is formed on the outer circumferential surfaces of the bare wires 12. At this time, the bare wire solder 14 enters the gaps between the bare wires 12, and is in intimate contact with all those regions of the outer circumferential surfaces of the bare wires 12 that are not in contact with another bare wire 12. In other words, all the regions of the outer circumferential surfaces of the bare wires 12 on which an oxide layer 17 may be formed is covered with the bare wire solder 14. Furthermore, the bare wire solder 14 is welded so as to cover not only the outer circumferential surface of the exposed end 11E but also the front end surface of the exposed end surface. That is, the front end surfaces of the bare wires 12 on which an oxide layer 17 may be formed are covered and hidden with the bare wire solder 14.

The terminal fitting 20 is formed by subjecting a plate material that is made of copper and was punched into a predetermined shape to bending or the like. As shown in FIG. 5, the terminal fitting 20 has, at its rear end, a crimping part 21 that is open barrel shaped. As shown in FIG. 6, the crimping part 21 includes a base plate part 22, and a pair of compression (crimping) pieces 23. The compression pieces 23 are shaped so as to extend from both the right and left edges of the base plate part 22 in the circumferential direction in a cantilever manner. The exposed end 11E of the conductor 11 is crimped to the crimping part 21 so as to be conductive thereto.

At the time of the crimping, an automatic machine that is referred to as an “applicator” is used. In the automatic machine, the exposed end 11E of the conductor 11 is placed on the base plate part 22, and then the pair of compression pieces 23 is deformed and wound onto the outer circumference of the exposed end 11E. As shown in FIG. 6, by compression of the pair of compression pieces 23, the crimping part 21 surrounds the entire circumference of the exposed end 11E while compressing it. In the crimped state, the inner surface of the base plate part 22 and the inner surfaces of the pair of compression pieces 23 are in contact with the outer layer part 15 of the bare wire solder 14 in a surface-contact state. Furthermore, the extension end parts 23E of the pair of compression pieces 23 penetrate the outer layer part 15 of the bare wire solder 14 in a state in which the outer surfaces of the extension end parts 23E are in surface-contact with each other, and are in direct contact with the bare wires 12.

Furthermore, in the crimping process, the compression pieces 23 compress the outer circumference of the conductor 11. In the present embodiment, as shown in FIG. 5, the portion of the conductor 11 (exposed end 11E) in the length direction of the conductor 11 that is compressed by the compression pieces 23 is not the entire but only a part (central region in the lateral direction) of that region of the exposed end 11E to which the bare wire solder 14 is welded. That is, the front end part and the rear end part of that region of the exposed end 11E to which the bare wire solder 14 is welded are not compressed by the crimping part 21.

Furthermore, since the pair of compression pieces 23 surround the conductor 11 so that the extension end parts 23E of the compression pieces 23 abut against each other in the circumferential direction, there is the risk of the compression pieces 23 being separated from each other in the circumferential direction due to springback. The separation of the pair of compression pieces 23 from each other may cause the risk that the crimping part 21 expands and becomes open, and a part of the crimping part 21 is separated from the outer layer part 15 of the bare wire solder 14 or the bare wires 12 are separated from each other. Therefore, crimping solder 24 is welded to that region of the outer circumference of the crimped crimping part 21 in that the extension end parts 23E of the pair of compression pieces 23 abut against each other, so as to connect the compression pieces 23 in the circumferential direction. The fixing strength of this crimping solder 24 restricts the separation of the pair of compression pieces 23 in the circumferential direction, preventing the crimping part 21 from expanding, becoming open, and deforming. Accordingly, the bare wires 12 are reliably prevented from being separated from each other, and the contact reliability between the electric wire 10 and the terminal fitting 20 is ensured.

The conduction path A according to the present embodiment includes the conductor 11 obtained by twisting the plurality of bare wires 12 that are made of aluminum and from which the oxide layer 17 is removed, the bare wire solder 14 that is welded to the conductor 11 so as to restrict relative displacement of the plurality of bare wires 12, and the terminal fitting 20 having the crimping part 21 that surrounds and crimps the region of the conductor 11 to which the bare wire solder 14 is welded. Also, the bare wires 12 are held by the fixing strength of the bare wire solder 14 so as not to be separated from each other. Accordingly, the contact reliability between the bare wires 12 is excellent.

Furthermore, in the conduction path A according to the present embodiment, the bare wire solder 14 is welded so as to surround the entire outer circumference of the conductor 11, and thus expansion of the conductor 11 is reliably restricted. Therefore, it is possible to reliably prevent the bare wires 12 from being separated from each other. Furthermore, since, in the conduction path A, the bare wire solder 14 is welded so as to cover the end surfaces of the plurality of bare wires 12 from which the oxide layer 17 is removed and that are bundled together, the bare wire solder 14 can enter the gaps between the bare wires 12, preventing creation of the oxide layer 17 within the conductor 11.

Furthermore, in the conduction path A of the present embodiment, the crimping part 21 includes the pair of compression pieces 23 extending in a cantilever manner so as to surround the conductor 11, and the extension end parts 23E of the compression pieces 23 penetrate the outer layer part 15 of the bare wire solder 14 surrounding the conductor 11 and are in direct contact with the bare wires 12. According to this configuration, the terminal fitting 20 and the conductor 11 are in direct contact with each other without the bare wire solder 14 therebetween, thus making it possible to prevent an increase in the electric resistance.

Furthermore, in the conduction path A of the present embodiment, that range of the conductor 11 in the length direction of the conductor 11 that is compressed by the crimping part 21 is only a part of the region of the conductor 11 to which the bare wire solder 14 is welded. According to this configuration, the area of the region to which the bare wire solder 14 is welded that is not compressed by the crimping part 21 has no risk that a crack occurs in the bare wire solder 14, thus making it possible to more reliably prevent the bare wires 12 from being separated from each other.

The present invention is not limited to the embodiment that has been described with reference to the specification above and the drawings, and the technical scope of the present invention encompasses, for example, the following embodiments.

Although in the above-described embodiment, the solder is welded so as to surround the entire outer circumference of the conductor, the solder may be welded so as to surround only a part of the outer circumference of the conductor.

Although in the above-described embodiment, the range of the conductor that is compressed by the crimping part is set to only a part of the region to which the solder is welded, the entire region to which the solder is welded may be compressed by the crimping part.

Although in the above-described embodiment, the extension end parts of the compression pieces of the crimping part penetrate the solder layer so as to be in direct contact with the bare wires of the conductor, the extension end parts of the compression pieces may remain within the solder layer so that the compression pieces and the bare wires are not in direct contact with each other.

Although in the above-described embodiment, the solder is welded to the outer circumference of the crimping part, as a measure for restricting expansion, opening, and deformation of the crimping part after the completion of crimping, a configuration is also possible in which the solder is not welded to the outer circumference of the crimping part.

Although in the above-described embodiment, the crimping part is open barrel shaped, the crimping part may be tubular, namely, closed barrel shaped.

1. A conduction path comprising:
a conductor including a plurality of aluminum bare wires from whose surfaces at an end an oxide layer is removed;
a solder that is welded to the conductor so as to restrict relative displacement of the plurality of bare wires from which the oxide layer is removed; and
a terminal fitting having a crimping part that surrounds and crimps a region of the conductor to which the solder is welded.

2. The conduction path according to claim 1,
wherein the solder is welded so as to surround an entire outer circumference of the conductor.

3. The conduction path according to claim 2,
wherein the crimping part has a pair of compression pieces that extend in a cantilever manner and surround the conductor, and
each of the pair of compression pieces have an extension end part that penetrates the solder surrounding the conductor and is in direct contact with a respective adjacent bare wire of the plurality of bare wires.

4. The conduction path according to claim 3,
wherein crimping solder is welded to the crimped on compression pieces.

5. The conduction path according claim 1,
wherein the solder is welded so as to cover end surfaces of the plurality of bare wires from which the oxide layer is removed and that are bundled together.

6. The conduction path according to claim 1,
wherein a range of the conductor in a conductor-length direction that is compressed by the crimping part is only a part of the region of the conductor to which the solder is welded.

7. An electric wire comprising:
a conductor including a plurality of aluminum bare wires from whose surfaces at an end an oxide layer is removed; and
solder that is welded to the conductor so as to restrict relative displacement of the plurality of bare wires from which the oxide layer is removed;
wherein a region of the conductor to which the solder is welded is configured to be crimped by a crimping part of a terminal fitting while being surrounded by the crimping part.

8. The electric wire according to claim 7,
wherein the solder is welded so as to surround an entire outer circumference of the conductor.

9. The electric wire according to claim 7,
wherein the solder is welded so as to cover end surfaces of the plurality of bare wires from which the oxide layer is removed and that are bundled together.

10. The conduction path according to claim 2, wherein the solder is welded so as to cover end surfaces of the plurality of bare wires from which the oxide layer is removed and that are bundled together.

11. The conduction path according to claim 3, wherein the solder is welded so as to cover end surfaces of the plurality of bare wires from which the oxide layer is removed and that are bundled together.

12. The conduction path according to claim 4, wherein the solder is welded so as to cover end surfaces of the plurality of bare wires from which the oxide layer is removed and that are bundled together.

13. The electric wire according to claim 8, wherein the solder is welded so as to cover end surfaces of the plurality of bare wires from which the oxide layer is removed and that are bundled together.

14. A method of manufacturing an electric wire, the method including the steps of;
providing a conductor including a plurality of aluminum bare wires from whose surfaces at an end an oxide layer is removed; and
providing a solder, welding the solder to the conductor so as to restrict relative displacement of the plurality of bare wires from which the oxide layer is removed; and wherein a region of the conductor to which the solder is welded is configured to be crimped by a crimping part of a terminal fitting while being surrounded by the crimping part.

15. The method as set forth in claim 14, wherein the solder is welded so as to surround an entire outer circumference of the conductor.

16. The method as set forth in claim 14, wherein the solder is welded so as to cover end surfaces of the plurality of bare wires from which the oxide layer is removed and that are bundled together.
